(19) United States
(12) Patent Application Publication
(10) Pub. No.: US 2016/0142349 A1
(43) Pub. Date: May 19, 2016

(54) MESSAGE GENERATION PROGRAM, MESSAGE GENERATION APPARATUS, AND MESSAGE GENERATION METHOD

(71) Applicant: FUJITSU LIMITED, Kawasaki-shi (JP)

(72) Inventors: YASUKO KAMIYAMA, YOKOHAMA (JP); Masahiro Kataoka, Kamakura (JP); Masao Ideuchi, Hachioji (JP)

(73) Assignee: FUJITSU LIMITED, Kawasaki-shi (JP)

(21) Appl. No.: 14/924,265

(22) Filed: Oct. 27, 2015

(30) Foreign Application Priority Data
Nov. 14, 2014 (JP) 2014-231950

(51) Int. Cl. H04L 12/58

(52) U.S. Cl. CPC H04L 51/066

(57) ABSTRACT

A non-transitory computer-readable storage medium storing therein a message generation program that causes a computer to execute a process includes converting a message generated according to occurrence of an event into converted data complying with a particular format, and transmitting a format information of the particular format, the converted data, and a restoring program, the restoring program restoring the message based on the format information and the converted data.

### CROSS-REFERENCE TO RELATED APPLICATION

This application is based upon and claims the benefit of priority of the prior Japanese Patent Application No. 2014-231950, filed on Nov. 14, 2014, the entire contents of which are incorporated herein by reference.

### FIELD

The present invention relates to a message generation program, a message generation apparatus, and a message generation method.

### BACKGROUND

A monitoring apparatus (hereinafter also referred to as a message browsing apparatus) that monitors, for example, a business system providing services to users (hereinafter also referred to as a monitoring target apparatus) monitors, for example, messages (hereinafter also referred to as event messages) output from the monitoring target apparatus. Thus, the monitoring apparatus checks the monitoring target apparatus for an operational status and the like. When an error message is output from the monitoring target apparatus, the monitoring apparatus determines that an abnormality has occurred in the monitoring target apparatus having output the error message, and for example, notifies an operational administrator of the error message.

The message output from the monitoring target apparatus as described above is typically output and transmitted to the monitoring apparatus in a text data format. That is, the message output from the monitoring target apparatus is output with no information on rules for the message (for example, information that identifies location of information such as variable information contained in the message; hereinafter also referred to as format information) (see for example, Japanese Laid-open Patent Publication No. 2013-214159).

### SUMMARY

An enormous number of messages may be output from the monitoring target apparatus depending on the numbers of applications, middleware applications, and the like operating in the monitoring target apparatus. Thus, the monitoring target apparatus typically compresses an output message using a ZIP scheme or the like before transmitting the message to the monitoring apparatus. Consequently, the monitoring target apparatus enables a reduction in the capacity of the message transmitted to the monitoring apparatus.

However, the compression according to the ZIP scheme is performed on each message based on a rule for the longest matching string. Thus, the monitoring target apparatus having received a message fails to extract message data or format information from the received message (compressed message). For example, the operational administrator fails to perform, for example, analysis of fault information based on the format information, in the monitoring apparatus.

Furthermore, when the monitoring target apparatus preliminarily defines format information on the message and transmits the format information to the monitoring apparatus, the monitoring apparatus can determine the format information corresponding to the received message. However, the monitoring apparatus needs to hold the format information on the message for each application and each middleware application from which the monitoring apparatus may receive output messages.

According to an aspect of the embodiments, a non-transitory computer-readable storage medium storing therein a message generation program that causes a computer to execute a process includes converting a message generated according to occurrence of an event into converted data complying to a particular format, and transmitting a format information of the particular format, the converted data, and a restoring program, the restoring program restoring the message based on the format information and the converted data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a general configuration of an information processing system.

FIG. 2 is a diagram illustrating specific examples of messages.

FIG. 3 is a diagram illustrating specific examples of messages.

FIG. 4 is a diagram illustrating specific examples of messages.

FIG. 5 is a diagram schematically illustrating a data creation process in the first embodiment.

FIG. 6 is a diagram schematically illustrating a data creation process in the first embodiment.

FIG. 7 is a diagram schematically illustrating a data creation process in the first embodiment.

FIG. 8 is a diagram schematically illustrating a data creation process in the first embodiment.

FIG. 9 is a diagram depicting a hardware configuration of the information processing system.

FIG. 10 is a functional block diagram of the monitoring target apparatus in FIG. 9.

FIG. 11 is a functional block diagram of the monitoring apparatus in FIG. 9.

FIG. 12 is a flowchart schematically illustrating the data creation process in the first embodiment.

FIG. 13 is a flowchart illustrating the details of the data creation process and the message restoration process in the first embodiment.

FIG. 14 is a flowchart illustrating the details of the data creation process and the message restoration process in the first embodiment.

FIG. 15 is a diagram illustrating the details of the data creation process and the message restoration process in the first embodiment.

FIG. 16 is a diagram illustrating the details of the data creation process and the message restoration process in the first embodiment.

FIG. 17 is a diagram illustrating the details of the data creation process and the message restoration process in the first embodiment.

FIG. 18 is a flowchart illustrating a data creation process and a message restoration process in the second embodiment.

FIG. 19 is a flowchart illustrating a data creation process and a message restoration process in the second embodiment.

FIG. 20 is a diagram illustrating the data creation process and the message restoration process in the second embodiment.

### DESCRIPTION OF EMBODIMENTS

[Configuration of the Information Processing System]

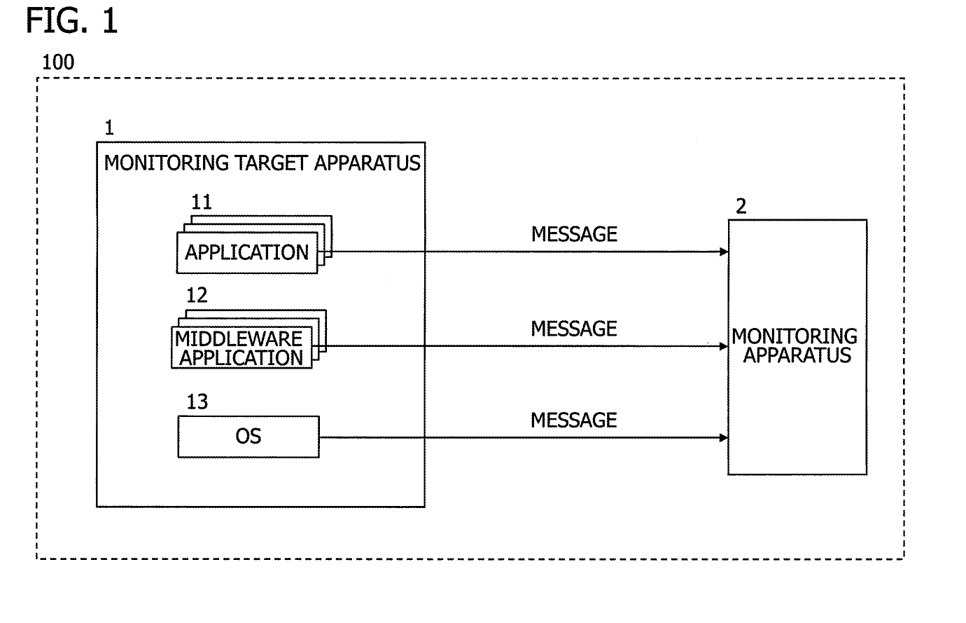

FIG. 1 is a diagram depicting a general configuration of an information processing system. An information processing system 100 depicted in FIG. 1 includes, for example, a monitoring target apparatus 1 in which, for example, a business system providing services to users is constructed and a monitoring apparatus 2 that monitors messages output from the monitoring target apparatus 1. The monitoring target apparatus 1 and the monitoring apparatus 2 each include one or more physical machines.

In an example in FIG. 1, for example, a plurality of applications 11, a plurality of middleware applications 12, and an operating system (OS) 13 operate in the monitoring target apparatus 1. The plurality of applications 11, the plurality of middleware applications 12, and the OS 13 each output messages to the monitoring apparatus 2.

The monitoring apparatus 2 accumulates received messages, for example, in order to enable an operational administrator to analyze the messages. The monitoring apparatus 2, for example, displays the received messages on a display apparatus (not depicted in the drawings) to enable the operational administrator to browse the messages.

The messages output by the monitoring target apparatus 1 are output when predefined events occur in the applications 11 or the like. The messages include information messages that are messages relating to operational statuses of the applications 11 or the like, for example, a message indicating that a job has ended normally. The messages also include warning messages that are messages attracting the attention of the operational administrator, for example, a message indicating that the remaining amount of a storage medium accessed by the application 11 or the like has decreased below a threshold. Moreover, the messages include error messages that are messages notifying the operational administrator that an abnormality has occurred in the application 11 or the like, for example, a message indicating that a job has ended abnormally. Consequently, the monitoring apparatus 2 can extract error messages that need to be dealt with by the operational administrator or the like from the messages received from the monitoring target apparatus 1 and notify the operational administrator of the error messages.

[Specific Examples of Messages]

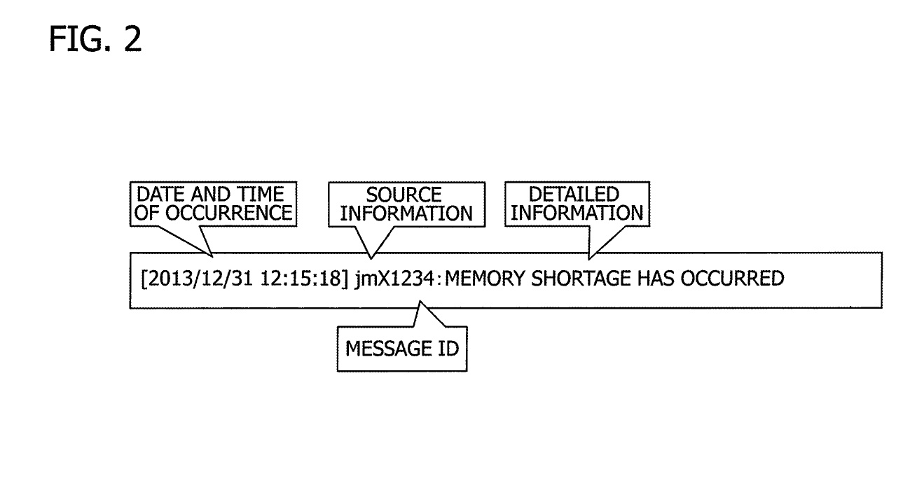

Now, specific examples of messages output by the application 11 and the like in the monitoring target apparatus 1. FIGS. 2 to 4 are diagrams illustrating specific examples of messages.

FIG. 2 depicts a specific example of message data from the monitoring target apparatus 1. In FIG. 2, a content “[2013/12/31 12:15:18] jmX1234: memory shortage has occurred” is generated in the message data from the monitoring target apparatus 1. The monitoring target apparatus 1 holds information indicating that a “[2013/12/31 12:15:18]” portion is the “date and time of occurrence”. The monitoring target apparatus 1 also holds information indicating that a “jmX” portion is “source information”, that a “1234” portion is a “message ID”, and that a “: memory shortage has occurred” portion is “detailed information”. That is, the monitoring target apparatus 1 has format information on messages output from the applications 11 or the like.

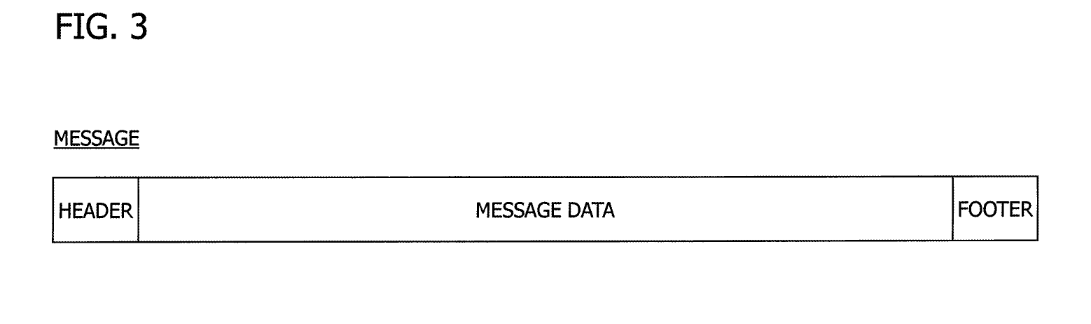

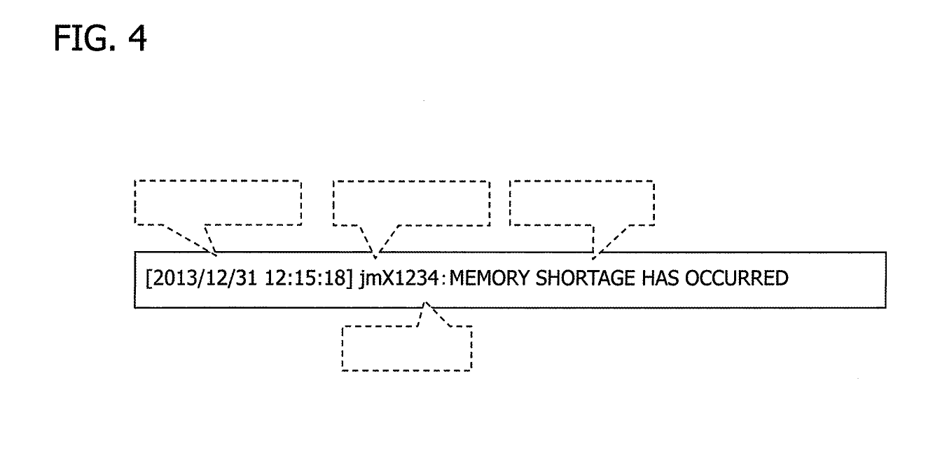

Now, a specific example will be described in which the monitoring target apparatus 1 transmits a message to the monitoring apparatus 2. FIG. 3 illustrates a specific example of a message transmitted from the monitoring target apparatus 1 to the monitoring apparatus 2. As depicted in FIG. 3, the message transmitted to the monitoring apparatus 2 by the monitoring target apparatus 1 has a header, message data, and a footer, and is output, for example, in a text data format. As depicted in FIG.4, when the monitoring target apparatus 1 outputs a message in the text data format, format information is lost from the output message.

An enormous number of messages may be output from the monitoring target apparatus 1 depending on the numbers of applications, middleware applications, and the like operating in the monitoring target apparatus 1. Thus, the monitoring target apparatus 1 typically compresses an output message using a ZIP scheme or the like before transmitting the message to the monitoring apparatus. Consequently, the monitoring target apparatus 1 enables a reduction in the capacity of the message transmitted to the monitoring apparatus 2. However, the compression according to the ZIP scheme is based on a rule for the longest matching string for each message. Thus, the monitoring apparatus 2 having received a message fails to restore message format information from the received message (compressed message).

Consequently, the operational administrator fails to perform, for example, analysis of fault information based on the format information, in the monitoring apparatus 2.

Thus, in the present embodiment, the monitoring target apparatus 1 transmits data (hereinafter also referred to as a converted message or composite data) including converted data (hereinafter also referred to as parameter information or message data) according to message format information (hereinafter also referred to simply as format), format information, and a restore program that restores a message based on the format information and the converted data. Consequently, the monitoring apparatus 2 can extract the converted data and the format information contained in the received data. The monitoring apparatus 2 can also restore the message output from the monitoring target apparatus 1.

### Brief Description of the First Embodiment

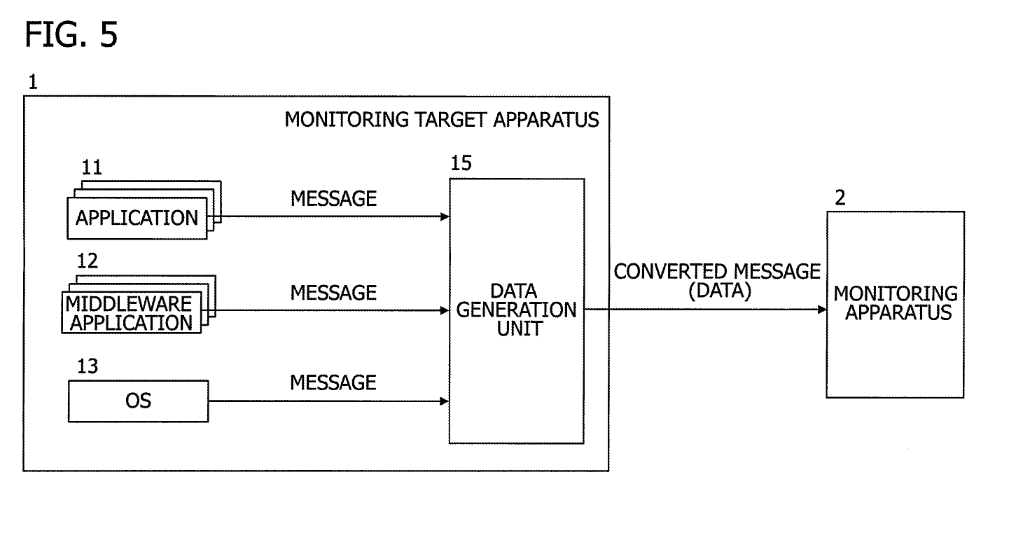

First, the first embodiment will be described in brief. FIGS. 5 to 8 are diagrams schematically illustrating a data creation process in the first embodiment.

As depicted in FIG. 5, the monitoring target apparatus 1 has a data generation unit 15 that acquires a message output by the application 11 or the like. The data generation unit 15 creates data based on the acquired message and transmits the data to the monitoring apparatus 2. That is, the monitoring target apparatus 1 in the first embodiment transmits the data into which the data generation unit 15 has converted the message output from the application 11 or the like, instead of transmitting the message to the monitoring apparatus 2 without any change.

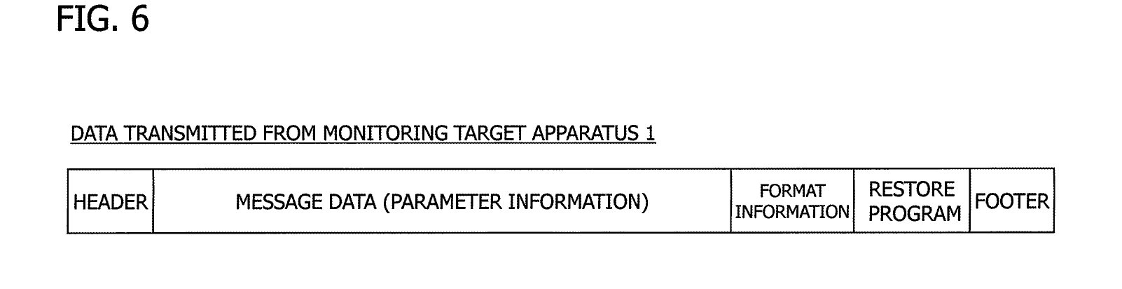

FIG. 6 is a diagram illustrating a specific example of data. As depicted in FIG. 6, the data has a header, message data (parameter information), format information, a restore program, and a footer. That is, the data in the first embodiment has format information that is information on a rule of the message and parameter information into which the message data has been converted based on the format information such that the format information and the parameter information are separate from each other. Consequently, the monitoring apparatus 2 having received the data can exclusively extract and utilize needed information from the format information and the parameter information included in the data.

The data also includes the restore program. Consequently, the monitoring apparatus 2 having received the data can, for example, restore message data in the text data format based on the format information and the parameter information.

Therefore, upon receiving the data from the monitoring target apparatus 1, the monitoring apparatus 2 in the first embodiment can selectively perform restoration of the message data based on execution of the restore program or utilization of the format information and the parameter information. That is, in accordance with the operational administrator's demand, the monitoring apparatus 2 can restore the message data or perform analysis or the like utilizing a part or all of the format information and the parameter information included in the data without restoring the message data. Specific examples of the parameter information and format information will be described below.

[Specific Example of Format Information]

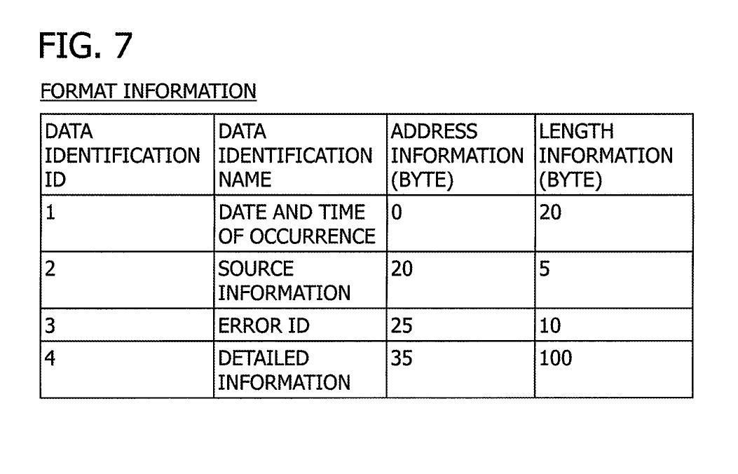

FIG. 7 is a diagram illustrating a specific example of the format information. The format information illustrated in FIG. 7 has, as items, “data identification IDs” that identifies data included in the format information and “data identification names” that are identification names of the data corresponding to the data identification IDs. The format information illustrated in FIG. 7 has “address information” indicative of the leading position of an area where data corresponding to each data identification name is stored and “length information” indicative of the data length of data corresponding to each data identification name. Specifically, in the format information illustrated in FIG. 7, for information with a “data identification ID” of 1, the date and time of occurrence is set for the “data identification name”, 0 (byte) is set for the “address information”, and 20 (bytes) is set for the “length information”. In the format information illustrated in FIG. 7, for information with a “data identification ID” of 2, source information is set for the “data identification name”, 20 (byte) is set for the “address information”, and 5 (bytes) is set for the “length information”. In the format information illustrated in FIG. 7, for information with a “data identification ID” of 3, an error ID is set for the “data identification name”, 25 (byte) is set for the “address information”, and 10 (bytes) is set for the “length information”. In the format information illustrated in FIG. 7, for information with a “data identification ID” of 4, detailed information is set for the “data identification name”, 35 (bytes) is set for the “address information”, and 100 (bytes) is set for the “length information”.

[Specific Examples of Parameter Information]

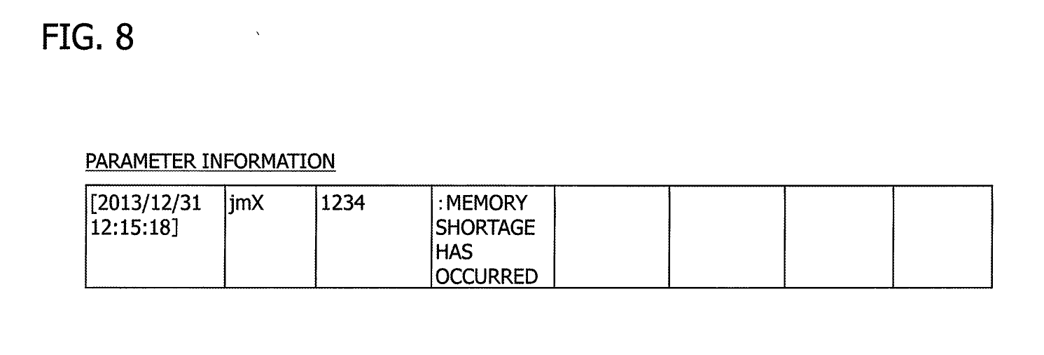

FIG. 8 is a diagram illustrating a specific example of parameter information created based on the format information illustrated in FIG. 7. The parameter information illustrated in FIG. 8 is created by, for example, dividing the message data contained in the message into data according to the data identification IDs included in the format information illustrated in FIG. 7, starting with the leading data of the message data and setting the resultant data in areas in the parameter information (in an example in FIG. 8, sequentially setting the data starting with the left end). Specifically, the data generation unit 15, for example, references the format information illustrated in FIG. 7 to acquire information set in a 20-byte area starting at the leading position of the message data, as data corresponding to the “date and time of occurrence”. As depicted in FIG. 8, the data generation unit 15 sets the acquired data “[2013/12/31 12:15:18]” in a leading area of the parameter information. The data generation unit 15 then references the format information illustrated in FIG. 7 to acquire information set in a 5-byte area starting at the 20th byte of the message data, as data corresponding to the “source information”. The data generation unit 15 then sets acquired data “jmX” in the second area in the parameter information as depicted in FIG. 8. Similarly, the data generation unit 15 sets data corresponding to the “error ID” and the “detailed information” in the third area and the fourth area, respectively, in the parameter information. Consequently, the data generation unit 15 can create the parameter information as depicted in FIG. 8.

That is, the monitoring target apparatus 1 in the first embodiment transmits, to the monitoring apparatus 2, the data including the format information and the parameter information such that the format information and the parameter information are separate from each other. Consequently, the monitoring target apparatus 1, which is a data source, and the monitoring apparatus 2, which is a data destination, can share the format information. Thus, the monitoring apparatus 2 in the first embodiment can, for example, determine a content of the message data without the need to pre-record the format information.

[Hardware Configuration of the Information Processing System]

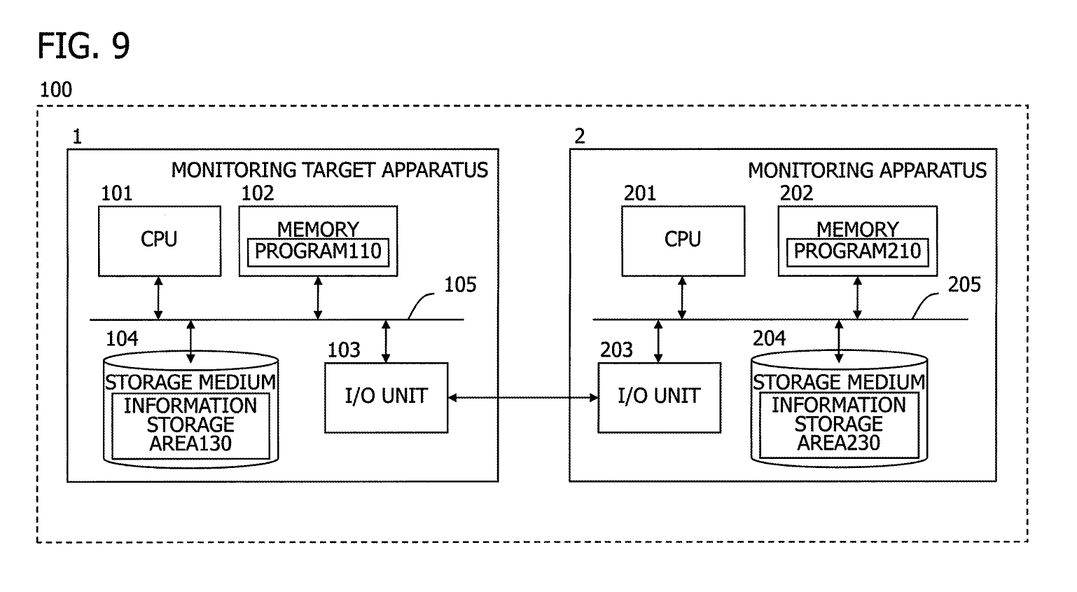

Now, a configuration of an information processing system 100 will be described. FIG. 9 is a diagram depicting a hardware configuration of the information processing system.

The monitoring target apparatus 1 has a CPU 101 that is a processor, a memory 102, an external interface (I/O unit) 103 through which the monitoring target apparatus 1 accesses the monitoring apparatus 2, and a storage medium 104. These units are connected together via a bus 105. The storage medium 104 stores, for example, in a program storage area (not depicted in the drawings) in the storage medium 104, a program 110 that allows execution of a process of creating data (hereinafter also referred to as a data creation process or a message generation process) and the like. When the program 110 is executed, the CPU 101 loads the program 110 from the storage medium 104 into the memory 102 and cooperates with the program 110 in executing the data creation process, as depicted in FIG. 9. The storage medium 104 has, for example, an information storage area 130 in which information used when the data creation process is executed is stored.

The monitoring apparatus 2 has a CPU 201 serving as a processor, a memory 202, an external interface (I/O unit) 203, and a storage medium 204. These units are connected together via a bus 205. The storage medium 204 stores, for example, in a program storage area (not depicted in the drawings) in the storage medium 204, a program 210 that allows execution of a process (hereinafter also referred to as a message restoration process) of restoring message data (message data included in a message output by the application 11 or the like) from the data received from the monitoring target apparatus 1. When the program 210 is executed, the CPU 201 loads the program 210 from the storage medium 204 into the memory 202 and cooperates with the program 210 in executing the message restoration process, as depicted in FIG. 9. The storage medium 204 has, for example, an information storage area 230 in which information used when the message restoration process is executed is stored.

[Software Configuration of the Information Processing System]

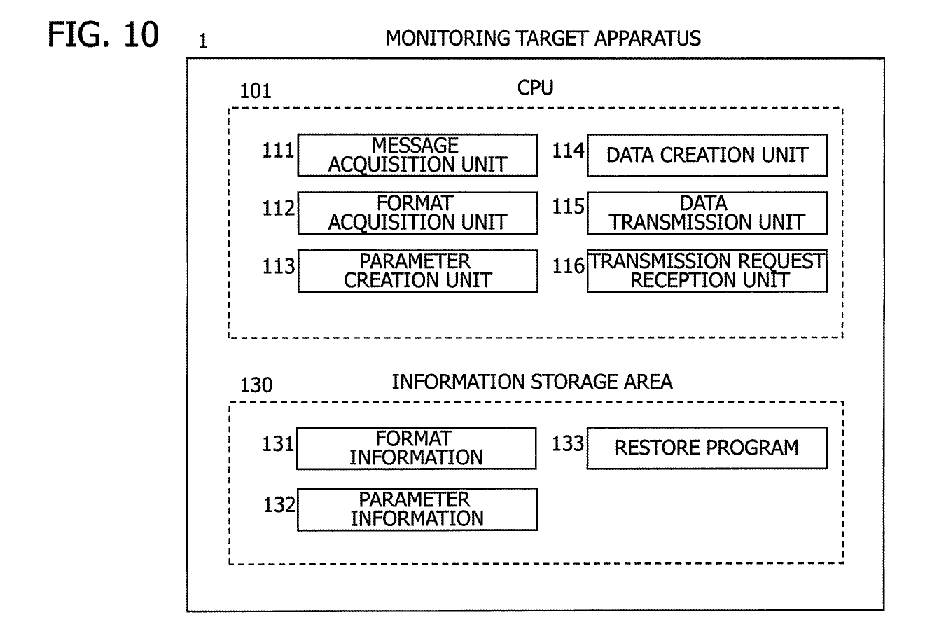

Now, a software configuration of the information processing system 100 will be described. FIG. 10 is a functional block diagram of the monitoring target apparatus in FIG. 9. The CPU 101 cooperates with the program 110 in operating as a message acquisition unit 111, a format acquisition unit 112, a parameter creation unit 113 (hereinafter also referred to as a conversion unit 113), a data creation unit 114, a data transmission unit 115, and a transmission request reception unit 116. In the information storage area 130, for example, format information 131, converted data 132 (hereinafter also referred to as parameter information 132), and a restore program 133 are stored. The data generation unit 15 depicted in FIG. 5 corresponds to the message acquisition unit 111, the format acquisition unit 112, the parameter creation unit 113, the data creation unit 114, the data transmission unit 115, and the transmission request reception unit 116.

The message acquisition unit 111, for example, acquires a message generated when a predetermined event has occurred in the application 11 or the like installed in the monitoring target apparatus 1. The predetermined event is, for example, a case where a process in execution has ended normally, a case where the amount of free space in the storage medium to be accessed is smaller than a threshold, or a case where the process in execution has ended abnormally.

The format acquisition unit 112, for example, acquires the format information 131 stored in the information storage area 130 when the message acquisition unit 111 acquires a message. The format information 131 includes a data identification name (hereinafter also referred to as type information) that identifies the type of data contained in a received message, address information (hereinafter also referred to as location information) that identifies the location of the data in the message, and length information on the data (hereinafter also referred to as a data length) such that the data identification name, the address information, and the length information are associated with one another, as depicted in FIG. 7.

The format acquisition unit 112, for example, creates and stores format information 131 in the information storage area 130 when the format information 131 corresponding to the message acquired by the message acquisition unit 111 is not stored in the information storage area 130. In this case, the format acquisition unit 112 accesses management information on the application 11 or the like having output the message and acquires information needed to create format information 131. In this case, information needed to create format information 131 may include, for example, layout information on the message output by the application 11 or the like. In this case, the operational administrator may store, for example, in the information storage area 130, information on a storage location where the management information on the application 11 or the like is stored.

The format acquisition unit 112 may use the acquired layout information as the format information 131. Also in this case, the operational administrator may store, for example, in the information storage area 130, information on a storage location where the management information on the application 11 or the like is stored.

The format acquisition unit 112 may reference the information on the storage location stored in the information storage area 130 to access the management information on the application 11 or the like having output the message.

The parameter creation unit 113, for example, acquires parameter information 132 from the message acquired from the application 11 or the like. The parameter information 132 is obtained by dividing the message data contained in the received message into data corresponding to the type information included in the format information 131. The parameter creation unit 113, for example, stores the created parameter information 132 in the information storage area 130.

The data creation unit 114, for example, creates data including the format information 131 acquired by the format acquisition unit 112, the parameter information 132 created by the parameter creation unit 113, and the restore program 133 that restores the message based on the format information 131 and the parameter information 132. The restore program 133 may be stored in the information storage area 130 before the message acquisition unit 111 acquires the message.

The data transmission unit 115, for example, transmits data created by the data creation unit 114 to the monitoring apparatus 2. For example, when the transmission request reception unit 116 described below receives a transmission request, the data transmission unit 115 transmits the format information 131 or the restore program 133 stored in the information storage area 130 to the monitoring apparatus 2.

The transmission request reception unit 116, for example, receives a transmission request described below when the transmission request is transmitted from the monitoring apparatus 2. The transmission request reception unit 116 requests the data transmission unit 115 to transmit information corresponding to the transmission request (the format information 131 or the restore program 133).

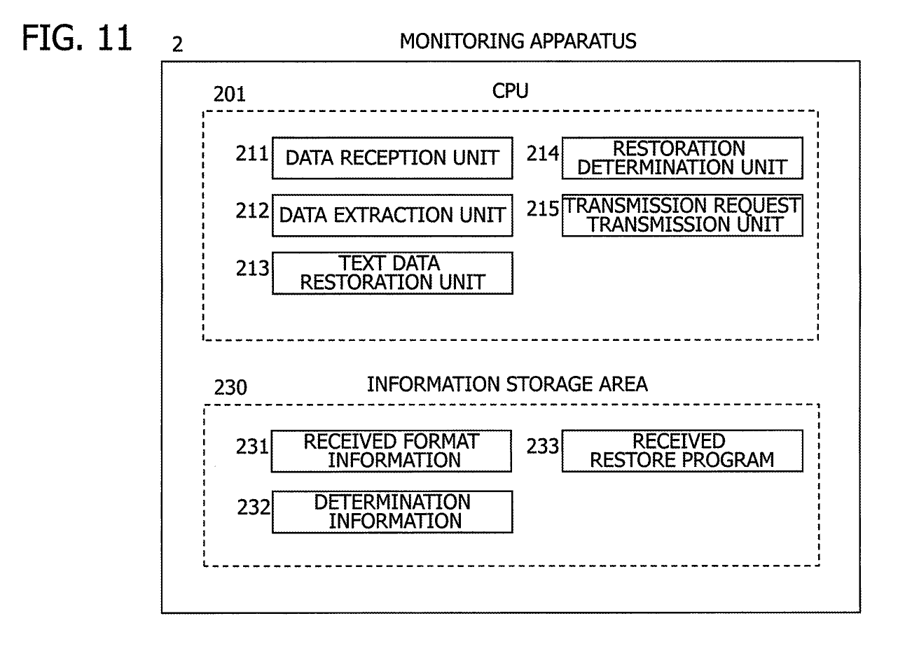

FIG. 11 is a functional block diagram of the monitoring apparatus in FIG. 9. The CPU 201 cooperates with the program 210 in operating as a data reception unit 211, a data extraction unit 212, a text data restoration unit 213, a restoration determination unit 214, and a transmission request transmission unit 215. In an information storage area 230, for example, format information 231 (hereinafter referred to as received format information 231), determination information 232, and a restore program 233 (hereinafter referred to as a received restore program 233) are stored.

The data reception unit 211, for example, receives data transmitted by the monitoring target apparatus 1.

The data extraction unit 212, for example, extracts information included in the data received by the data reception unit 211. That is, the data extraction unit 212, for example, extracts information needed for the operational administrator to perform analysis or the like based on an input from the operational administrator. In a specific example, the data extraction unit 212 extracts only the format information 131 included in the data received from the monitoring target apparatus 1 or extracts a portion which matches a content input by the operational administrator from the parameter information 132 included in the data received from the monitoring target apparatus 1.

The text data restoration unit 213, for example, executes the restore program 133 included in the data received from the monitoring target apparatus 1 to decompress the parameter information 132 included in the data received to from the monitoring target apparatus 1, into a text data format. Specifically, the text data restoration unit 213, for example, executes the restore program 133 to combine information included in the parameter information 132 in accordance with the content of the format information 131. Thus, the text data restoration unit 213 can restore the message data contained in the message output by the application 11 or the like.

For example, based on the determination information 232 that is set information on data restoration set therein, the restoration determination unit 214 determines whether to allow the data extraction unit 212 or the text data restoration unit 213 to execute processing on the data received from the monitoring target apparatus 1.

For example, when only the parameter information 132 is transmitted from the monitoring target apparatus 1, the transmission request transmission unit 215 determines whether or not the received format information 231 and the received restore program 233 corresponding to the parameter information 132 are stored in the information storage area 230. For example, when the received format information 231 and (or) the received restore program 233 are not stored, the transmission request transmission unit 215 transmits a transmission request for these pieces of information to the monitoring target apparatus 1.

### Flowchart Schematically Illustrating the First Embodiment

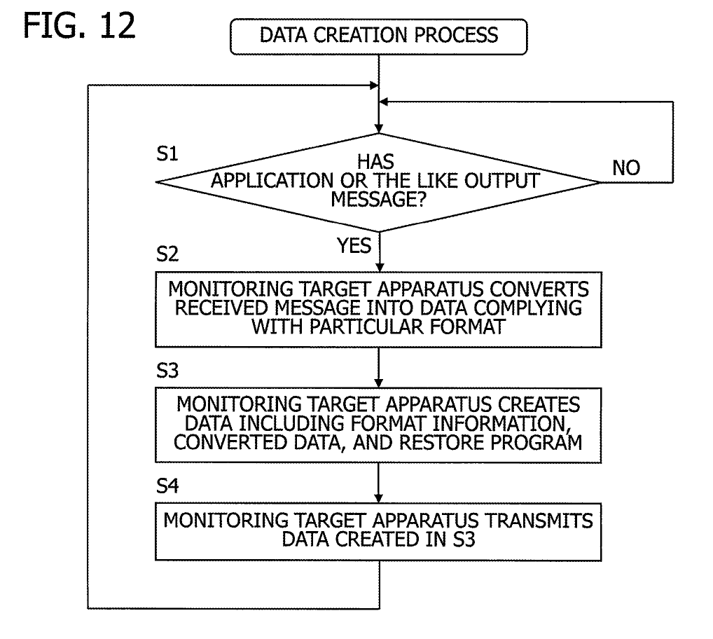

Now, the first embodiment will be described below in brief. FIG. 12 is a flowchart schematically illustrating the data creation process in the first embodiment.

First, the monitoring target apparatus 1 (data generation unit 15) waits until the application 11 or the like outputs a message (S1, NO). When the application 11 or the like outputs a message as depicted in FIG. 5 (S1, YES), the monitoring target apparatus 1 converts the output message into the parameter information 132 complying with the format information 131 (S2).

The parameter information 132 is created, for example, by dividing to the message data contained in the output message into data corresponding to type information included in the format information 131. The monitoring target apparatus 1 may create the parameter information 132 in accordance with the format information 131 during a process of compressing the message output from the application 11 or the like to transmit the message to the monitoring apparatus 2. The format information 131 and the parameter information 132 need to be able to be recognized by the monitoring apparatus 2. Thus, the monitoring target apparatus 1 creates the format information 131 and the parameter information 132 in a format (for example, the text data format) that can be recognized by the monitoring apparatus 2.

Then, the monitoring target apparatus 1 (data generation unit 15) creates data including, for example, the format information 131, the parameter information 132, and the restore program 133 stored in the information storage area 130 (S3). Moreover, the monitoring target apparatus 1 transmits the created data to the monitoring apparatus 2 (S4) as depicted in FIG. 5. Consequently, upon receiving the data from the monitoring target apparatus 1, the monitoring apparatus 2, for example, can extract the needed information from the data and perform, for example, analysis of the message output by the application 11 or the like based on the extracted data. Moreover, upon receiving the data from the monitoring target apparatus 1, the monitoring apparatus 2 can restore the message data contained in the message output by the application 11 or the like, by executing the restore program 133 contained in the data as needed.

As described above, in the first embodiment, the monitoring target apparatus 1 converts the message generated in accordance with occurrence of an event into parameter information 132 (converted data 132) complying with the format information 131 corresponding to the message. Moreover, the monitoring target apparatus 1 transmits the format information 131, the parameter information 132 resulting from the conversion and complying with the format information 131, and the restore program 133 that restores the message. Consequently, the monitoring apparatus 2 can restore the message data contained in the message output from the monitoring target apparatus 1 based on the data received from the monitoring target apparatus 1. Furthermore, the monitoring apparatus 2 can, for example, extract all or a part of the format information 131 and the parameter information 132 included in the received data.

The monitoring target apparatus 1 may extract only error messages from the messages output by the applications 11 or the like to create parameter information 132 from the message data contained in each of the error messages. The monitoring target apparatus 1 may transmit only the data including the parameter information 132 created from the message data contained in the error message. This enables the monitoring target apparatus 1 to, for example, transmit, to the monitoring apparatus 2, only the information on messages needed to be dealt with by the monitoring apparatus 2.

Moreover, the data creation unit 114 may create data such that the data includes location information enabling the locations of the format information 131, the parameter information 132, or the restore program 133 to be identified. Specifically, the data creation unit 114 sets location information in the leading portion of the data. As a result, the monitoring apparatus 2 can easily extract the format information 131 or the like from the received data.

### Details of the First Embodiment

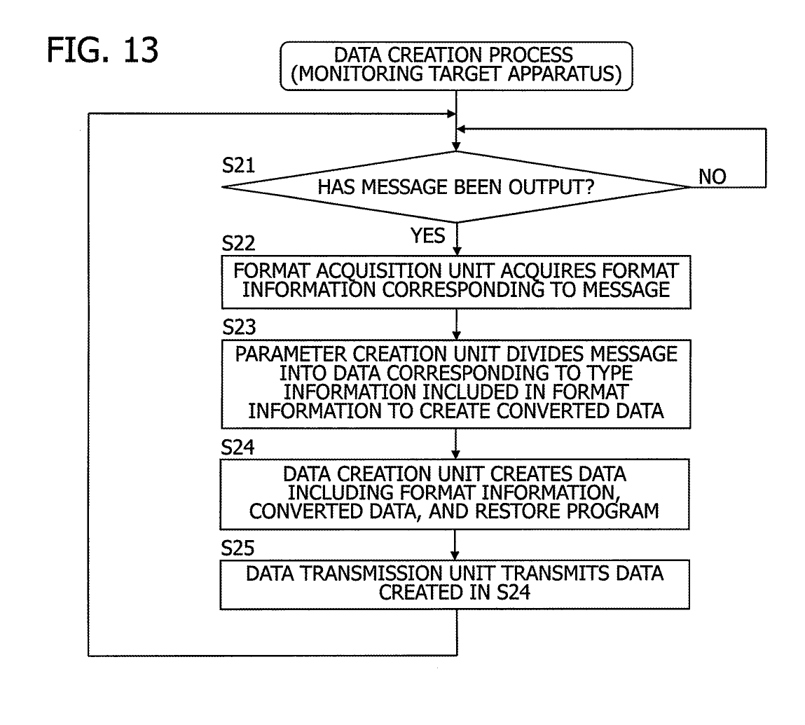

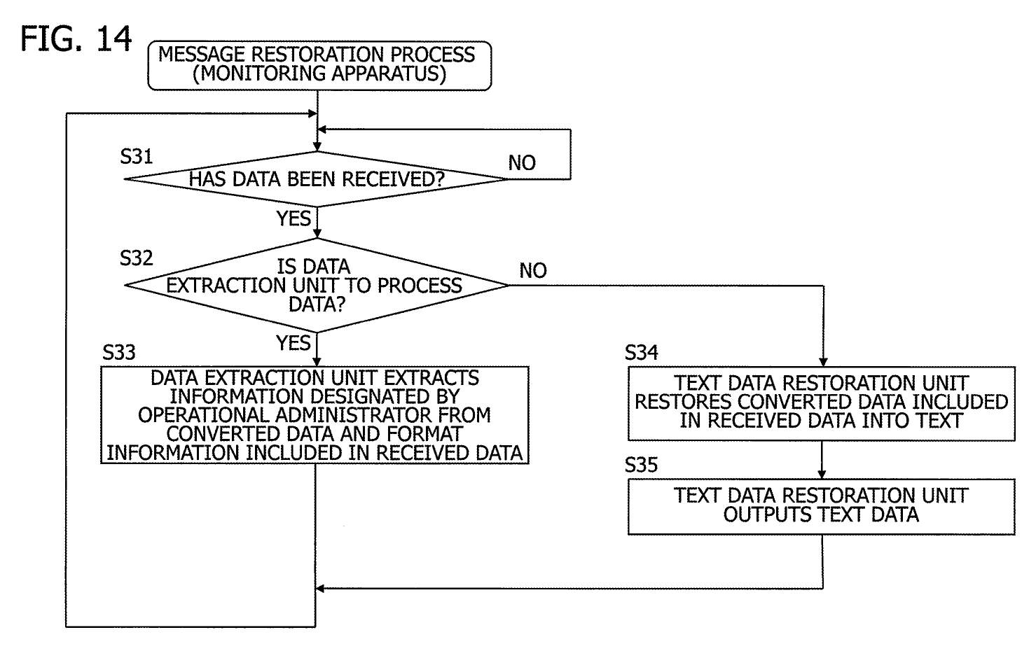

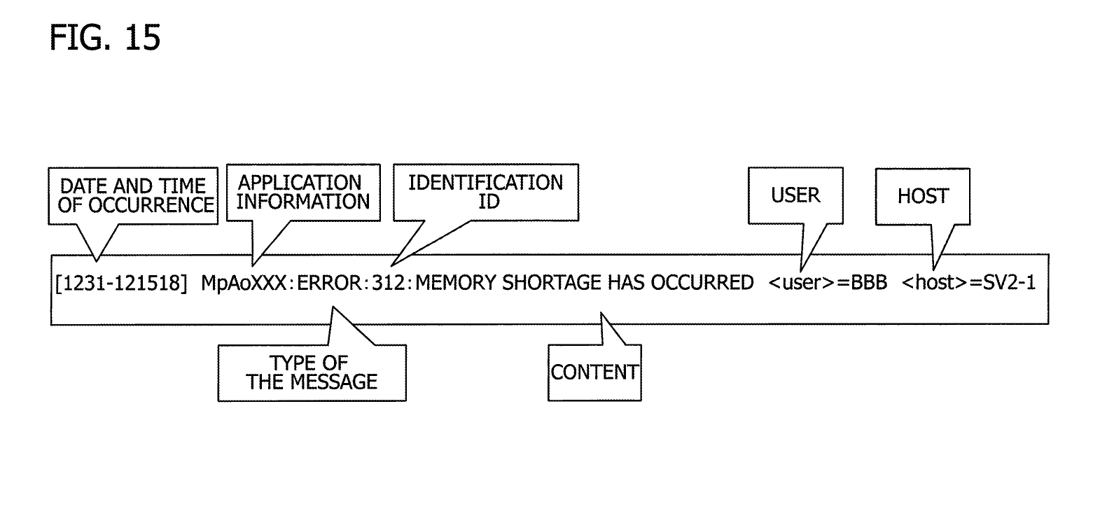

Now, the details of the first embodiment will be described. FIG. 13 and FIG. 14 are flowcharts illustrating the details of the data creation process and the message restoration process in the first embodiment. FIGS. 15 to 17 are diagrams illustrating the details of the data creation process and the message restoration process in the first embodiment. With reference to FIGS. 15 to 17, the data creation process and the message restoration process in FIG. 13 and FIG. 14 will be described in detail.

[Details of the Data Creation Process]

First, the data creation process executed in the monitoring target apparatus 1 will be described in detail. The message acquisition unit 111 in the monitoring target apparatus 1 waits until the application 11 or the like outputs a message (S21, NO). When the application 11 or the like outputs a message (S21, YES), the format acquisition unit 112, for example, acquires the format information 131 corresponding to the output message (S22). Specifically, the format acquisition unit 112 acquires the format information 131 corresponding to the acquired message from the information storage area 130. Then, when the format information 131 corresponding to the acquired message is not stored in the information storage area 130, the format acquisition unit 112 accesses the management information on the application 11 or the like having output the message to create the format information 131.

Then, the parameter creation unit 113, for example, divides the message data contained in the message acquired by the message acquisition unit 111 into data corresponding to the type information included in the format information 131, to create parameter information 132 (S23). Subsequently, the data creation unit 114, for example, creates data including the format information 131 created by the format acquisition unit 112, the parameter information 132 created by the parameter creation unit 113, and the restore program 133 (S24). Then, the data transmission unit 115 transmits the created data to the monitoring apparatus 2 (S25). Specifically, the data transmission unit 115, for example, adds a header and a footer to the data including the format information 131, the parameter information 132, and the restore program 133 and transmits the resultant data as depicted in FIG. 6.

The data transmission unit 115, for example, may set identification information indicating that data depicted in FIG. 6 is data including the format information 131, in a leading portion of the header contained in the data depicted in FIG. 6. Thus, for example, upon receiving a mixture of the data transmitted from the monitoring target apparatus 1 and the message as output from the application 11 or the like, the monitoring apparatus 2 can easily determine whether or not the received data has been received from the monitoring target apparatus 1.

[Other Specific Examples of the Format Information and the Parameter Information]

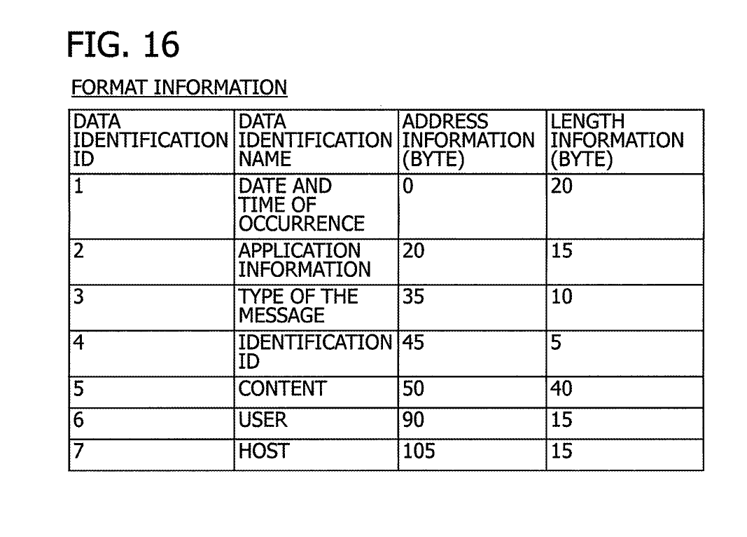

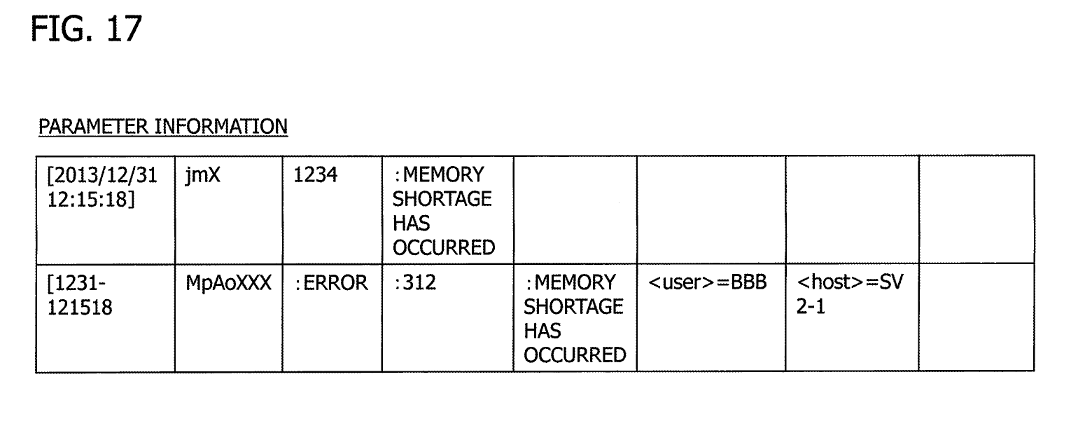

FIGS. 15 to 17 are diagrams illustrating other specific examples of the format information 131 and the parameter information 132. FIG. 15, like FIG. 2, illustrates a specific example of a case where message data is output to a display screen of the monitoring target apparatus 1. FIG. 16, like FIG. 7, illustrates a specific example of the format information 131, and FIG. 17, like FIG. 8, illustrates a specific example of the parameter information 132. Differences from the format information 131 and the parameter information 132 described with reference to FIG. 7 and FIG. 8 will be described below.

In FIG. 15, a content “[1231-121518]MpAoXXX: error: 312: memory shortage has occurred <USER>=BBB<host>=SV2-1” is generated in message data from the monitoring target apparatus 1. In this example, the monitoring target apparatus 1 holds information indicating that a “[1231-121518]” portion is the “date and time of occurrence”. The monitoring target apparatus 1 also holds information indicating that an “MpAoXXX” portion is “application information” on the application 11 or the like corresponding to the message source and that an “error” portion is the “type of the message”. The monitoring target apparatus 1 further holds information indicating that a “312” portion is an “identification ID” that is an ID identifying the message and that a “memory shortage has occurred” portion is a “content” that is information on the occurring event. Furthermore, in the example illustrated in FIG. 15, the monitoring target apparatus 1 holds information indicating that a “<USER>=BBB” portion is “USER” that identifies a managing user for the application 11 or the like corresponding to the message source. In the example illustrated in FIG. 15, the monitoring target apparatus 1 holds information indicating that a “<host>=SV2-1” portion is “HOST” that identifies a host in which the application 11 or the like corresponding to the message source operates.

Therefore, under the “data identification name” in the format information 131 illustrated in FIG. 16, the information on the date and time of occurrence, the application, the type of the message, the identification ID, the content, and USER and HOST is set as in the case of FIG. 7. The description of the other pieces of information in FIG. 16 is omitted.

The parameter information 132 illustrated in FIG. 17 is a specific example of a case where the information on the message based on the information illustrated in FIG. 15 is set after the state of the parameter information 132 illustrated in FIG. 8. The parameter information 132 illustrated in FIG. 17 is created by dividing the message data contained in the message illustrated in FIG. 15 into data according to the type information included in the format information 131, starting with a leading portion of the message data, as in the case of FIG. 8. Specifically, the parameter creation unit 113 sets, in the second column area in the parameter information 132, data corresponding to the “date and time of occurrence”, the “application information”, the “type of the message”, the “identification ID”, the “content”, and “USER” and “HOST” set under the “data identification name” in the format information 131 illustrated in FIG. 16.

[Details of the Message Restoration Process]

With reference to FIG. 14, the message restoration process executed in the monitoring apparatus 2 will be described. The data reception unit 211 of the monitoring apparatus 2, for example, waits until the data reception unit 211 receives data from the monitoring target apparatus 1 (S31, NO). Upon receiving data from the monitoring target apparatus 1 (S31, YES), the restoration determination unit 214, for example, references the determination information 232 to determine whether or not the data extraction unit 212 is to process the received data (S32). That is, the restoration determination unit 214 determines whether the data extraction unit 212 or the text data restoration unit 213 executes processing on the received data based on the determination information 232 in which the information on the data restoration is set.

When the information indicating that the data extraction unit 212 is to process the data received from the monitoring target apparatus 1 is set in the determination information 232 (S32, YES), the data extraction unit 212, for example, extracts information which is included in the format information 131 and the parameter information 132 included in the received data and which is designated by the operational administrator in order to perform analysis of the message and the like (S33). On the other hand, when the information indicating that the data extraction unit 212 is to process the data received from the monitoring target apparatus 1 is not set in the determination information 232 (S32, NO), the text data restoration unit 213, for example, restores the parameter information 132 into the text data format (S34). The text data restoration unit 213, for example, outputs the restored text data (S35).

That is, upon receiving data from the monitoring target apparatus 1, the restoration determination unit 214 can selectively perform restoration of the message data based on execution of the restore program 133 or utilization of the format information 131 and the parameter information 132. That is, the restoration determination unit 214 can, for example, allow the data extraction unit 212 to execute processing in order to restore the message data in accordance with the operational administrator's demand. Furthermore, the restoration determination unit 214 can, for example, allow the text data restoration unit 213 to execute processing in order to extract the format information 131 and the parameter information 132 included in the data received from the monitoring target apparatus 1, without the need to restore the message data, in accordance with the operational administrator's demand.

The operational administrator may change information set in the determination information 232 in accordance with a change in monitoring conditions or the like based on a user's demand, to change a method of processing the data received from the monitoring target apparatus 1. Specifically, the monitoring apparatus 2 may change the content of the determination information 232 when the number of composite data received by the data reception unit 211 (for example, 100) is exceeded. Moreover, upon receiving the data from the monitoring target apparatus 1, the data reception unit 211 may first check the leading portion of the received data. When no identification information is set in the leading portion of the data, the data reception unit 211 may determine that the received data is not the data transmitted from the monitoring target apparatus 1, and continue to wait until the next data is transmitted from the monitoring target apparatus 1 (S31, NO).

### Second Embodiment

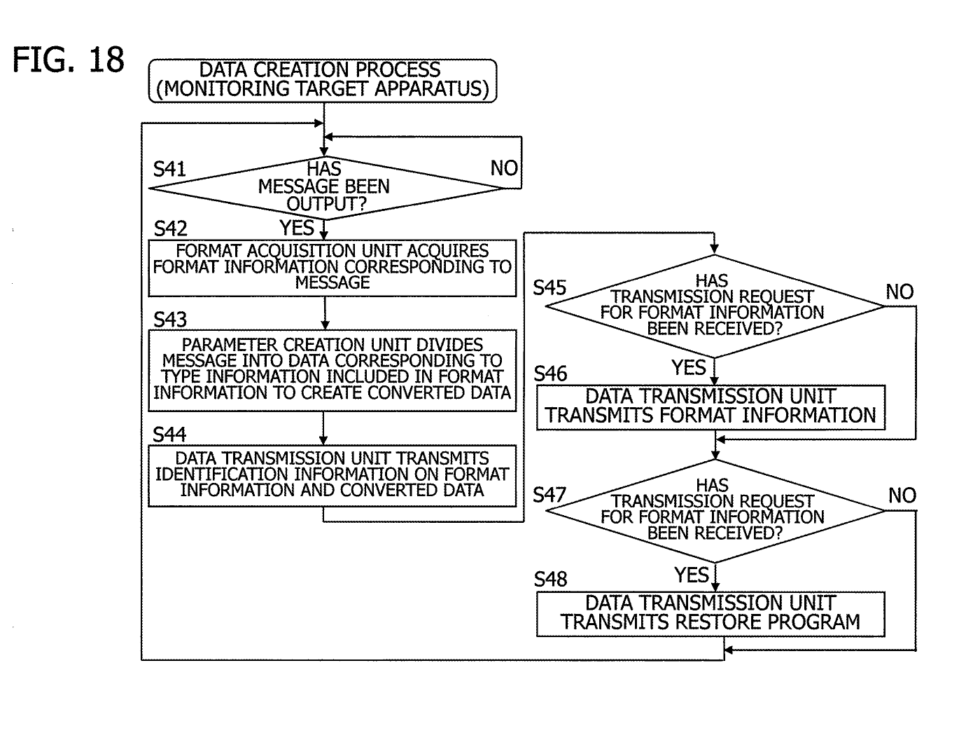

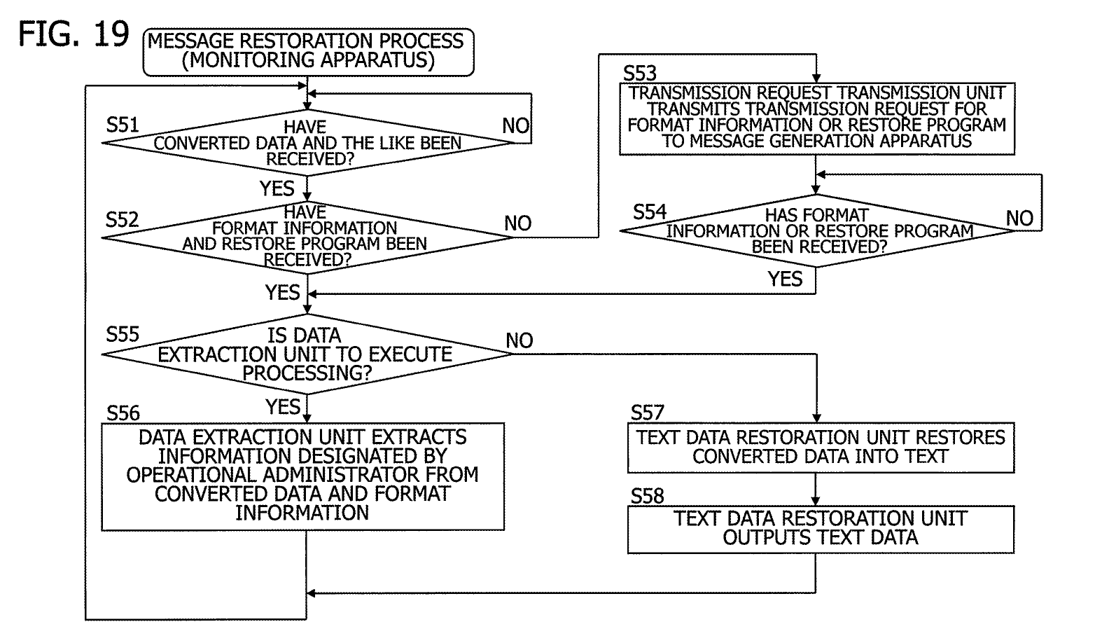

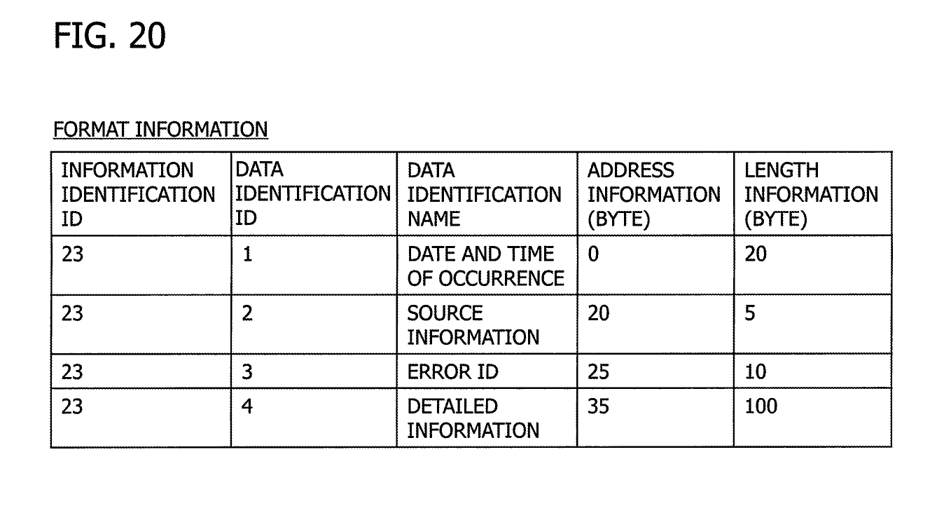

Now, a second embodiment will be described. FIG. 18 and FIG. 19 are flowcharts illustrating a data creation process and a message restoration process in the second embodiment. FIG. 20 is a diagram illustrating the data creation process and the message restoration process in the second embodiment. The data creation process and the message restoration process in FIG. 18 and FIG. 19 will be described with reference to FIG. 20. Differences of FIG. 20 from FIG. 7 will be described.

In the second embodiment, the monitoring target apparatus 1 transmits the parameter information 132 when the application 11 or the like outputs a message, unlike in the first embodiment. Upon receiving the parameter information 132, the monitoring apparatus 2 checks whether format information used to restore the received parameter information 132 (hereinafter also referred to as received format information 231) and a restore program (hereinafter also referred to as a received restore program 233) have been received. As a result, when the received format information 231 and the received restore program 233 corresponding to the received parameter information 132 have been received, the monitoring apparatus 2 executes a process of restoring the parameter information 132 based on these pieces of information. On the other hand, when the received format information 231 and the received restore program 233 corresponding to the received parameter information 132 have not been received, the monitoring apparatus 2 requests the monitoring target apparatus 1 to transmit the format information 131 and the restore program 133 corresponding to the monitoring target apparatus 1.

That is, the monitoring target apparatus 1 in the second embodiment transmits only the parameter information 132 to the monitoring apparatus 2 instead of transmitting the data each time a message is generated. Then, when the information used to restore the received parameter information 132 has not been received, the monitoring apparatus 2 requests the monitoring target apparatus 1 to transmit the needed information. Consequently, the monitoring target apparatus 1 can reduce the amount of information transmitted to the monitoring apparatus 2. The data creation process and the message restoration process in the second embodiment will be described in detail.

[Data Creation Process]

First, the message acquisition unit 111 waits until the application 11 or the like outputs a message (S41, NO). When a message is output (S41, YES), the format acquisition unit 112, for example, acquires the format information 131 corresponding to the output message (S42). The format acquisition unit 112 in the second embodiment creates format information 131 such that the format information 131 includes an “information identification ID” that is information identifying the format information 131. The “information identification ID” may be incremented in value each time the format acquisition unit 112 creates format information 131. The format acquisition unit 112, for example, stores the created format information 131 in the information storage area 130. Thus, the monitoring target apparatus 1 and the monitoring apparatus 2 can identify information to be transmitted or received based on the information indicated by the “information identification ID”. A specific example of the format information 131 in the second embodiment will be described below.

FIG. 20 illustrates the format information 131 described with reference to FIG. 7 and to which the “information identification ID” has been added as an item. In an example in FIG. 20, 23 is stored as the “information identification ID” for each of the data included in the format information 131. That is, this indicates that the format information 131 illustrated in FIG. 20 is the 23rd piece of the format information 131 created by the format acquisition unit 112. Furthermore, the format acquisition unit 112 sets the same “information identification ID” as that for the created format information 131, for the restore program 133 used simultaneously with the created format information 131.

Subsequently, as is the case with the first embodiment, the parameter creation unit 113, for example, divides the message acquired by the message acquisition unit 111 into data corresponding to the type information included in the format information 131, to create parameter information 132 (S43).

Then, unlike in the first embodiment, the data transmission unit 115, for example, transmits information with the “information identification ID” set for the format information 131 and the parameter information 132 to the monitoring apparatus 2 (S44). That is, in the second embodiment, when the application 11 or the like outputs a message, the monitoring target apparatus 1 transmits information with the “information identification ID” set for the format information 131 and the parameter information 132 without creating the composite data.

When the transmission request reception unit 116 receives a transmission request for the format information 131 (S45, YES), the data transmission unit 115 transmits the format information 131 corresponding to the parameter information 132 transmitted in S44 (S46). That is, when the transmission request for the format information 131 is received from the monitoring apparatus 2, this means that the format information 131 corresponding to the parameter information 132 transmitted in S44 is not stored in the monitoring apparatus 2. Thus, the data transmission unit 115 transmits the format information 131 based on the transmission request. On the other hand, when the transmission request for the format information 131 is not received from the monitoring apparatus 2 (S45, NO), the data transmission unit 115 does not transmit the format information 131. In transmitting the transmission request to the monitoring target apparatus 1, the monitoring apparatus 2 includes, in the transmission request, the “information identification ID” received from the monitoring target apparatus 1 simultaneously with the parameter information 132. Then, upon receiving the transmission request, the monitoring target apparatus 1 can identify the format information 131 to be transmitted to the monitoring apparatus 2.

Moreover, when the transmission request reception unit 116 receives a transmission request for the restore program 133 (S47, YES), the data transmission unit 115 transmits the restore program 133 corresponding to the parameter information 132 transmitted in S44 (S48). That is, when the transmission request for the restore program 133 is received from the monitoring apparatus 2, this means that the restore program 133 corresponding to the parameter information 132 transmitted in S44 is not stored in the monitoring apparatus 2. Thus, the data transmission unit 115 transmits the restore program 133. On the other hand, when the transmission request for the restore program 133 is not received from the monitoring apparatus 2 (S47, NO), the data transmission unit 115 does not transmit the restore program 133. In transmitting the transmission request to the monitoring target apparatus 1, the monitoring apparatus 2 includes, in the transmission request, the “information identification ID” received from the monitoring target apparatus 1 simultaneously with the parameter information 132. Then, upon receiving the transmission request, the monitoring target apparatus 1 can identify the restore program 133 to be transmitted to the monitoring apparatus 2.

[Message Restoration Process]

Now, the message restoration process in the second embodiment will be described. First, the data reception unit 211 waits until the data reception unit 211 receives the parameter information 132 and the information indicative of the “information identification ID” from the monitoring target apparatus 1 (S51, NO). When the data reception unit 211 receives the parameter information 132 and the like transmitted from the monitoring target apparatus 1 (S51, YES), the transmission request transmission unit 215, for example, references the received format information 231 and the received restore program 233 stored in the information storage area 230 based on the received information indicative of the “information identification ID”. That is, the transmission request transmission unit 215 searches the received format information 231 and the received restore program 233 stored in the information storage area 230 for information for which the “information identification ID” matching the received “information identification ID” is set. When the received format information 231 and the received restore program 233 corresponding to the received parameter information 132 are stored (S52, YES), the restoration determination unit 214 and the like execute processing for restoring the received parameter information 132 (S55 and the like) as is the case with the first embodiment.

On the other hand, when the received format information 231 and the received restore program 233 corresponding to the received parameter information 132 are not stored (S52, NO), the transmission request transmission unit 215, for example, transmits a transmission request to the monitoring target apparatus 1 (S53). Specifically, the transmission request transmission unit 215 transmits, to the monitoring target apparatus 1, a transmission request for information which is included in the received format information 231 and the received restore program 233 needed to restore the received parameter information 132 and which has not been received by the monitoring apparatus 2. Incidentally, the transmission request includes an “information identification ID” for identifying information related to the transmission request. As a result, the monitoring target apparatus 1 having received the transmission request can identify the information to be transmitted to the monitoring apparatus 2.

Then, the data reception unit 211, for example, waits until the data reception unit 211 receives information corresponding to the transmission request (S54, NO). When the data reception unit 211 receives the information corresponding to the transmission request (S54, YES), the restoration determination unit 214 and the like execute processing for restoring the received parameter information 132 as is the case with the first embodiment (S55 and the like). Processing from S55 to S58 has the same content as that of the processing from S32 to S35 described with reference to FIG. 14 and will thus not be described below.

That is, in the second embodiment, the monitoring target apparatus 1 transmits the parameter information 132 to the monitoring apparatus 2 when a message is generated. Then, when not having received the received format information 231 or the received restore program 233 corresponding to the received parameter information 132, the monitoring apparatus 2 transmits a transmission request to the monitoring target apparatus 1. Accordingly, the monitoring target apparatus 1 do not need to transmit all of the data to the monitoring apparatus 2 each time a message is output from the application 11 or the like. Thus, the monitoring target apparatus 1 enables a reduction in the amount of information transmitted to the monitoring apparatus 2. Specifically, the monitoring target apparatus 1, for example, enables prevention of repeated transmission of the same information (format information 131) to the monitoring apparatus 2 when messages are frequently output from the same application 11 or the like. Consequently, the monitoring target apparatus 1 enables efficient transmission of information to the monitoring apparatus 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a message generation program that causes a computer to execute a process comprising:
converting a message generated according to occurrence of an event into converted data complying with a particular format; and
transmitting a format information of the particular format, the converted data, and a restoring program, the restoring program restoring the message based on the format information and the converted data.

2. The non-transitory computer-readable storage medium according to claim 1, wherein the converting includes converting an error message included in the generated message and indicating that an abnormality occurred into the converted data.

3. The non-transitory computer-readable storage medium according to claim 1, further comprising:
creating the format information, before the converting, by associating type information identifying a type of data contained in the generated message, location information identifying a location of data corresponding to the type information, and a data length of the data corresponding to the type information.

4. The non-transitory computer-readable storage medium according to claim 3, wherein
the converting includes converting the massage into the converted message by dividing the massage into data corresponding to the type information.

5. The non-transitory computer-readable storage medium according to claim 1, wherein
the transmitting includes transmitting data including the format information, the converted data, and the program,
the data includes, at a leading position of the data, location information enabling a location of the format in the data to be identified.

6. The non-transitory computer-readable storage medium according to claim 2, wherein
the transmitting includes transmitting the converted data converted from the error message.

7. The non-transitory computer-readable storage medium according to claim 1, wherein
the transmitting includes:
transmitting the format information in response to receiving a transmission request for the format information, and
transmitting the program in response to receiving a transmission request for the program.

8. A message generation method comprising:
converting, by a processor, a message generated according to occurrence of an event into converted data complying with a particular format; and
transmitting, by a processor, a format information of the particular format, the converted data, and a restoring program, the restoring program restoring the message based on the format information and the converted data.

9. A message generation apparatus comprising:
a conversion processor that converts a message generated according to occurrence of an event into converted data complying with a particular format; and
a transmission processor that transmits a format information of the particular format, the converted data, and a restoring program, the restoring program restoring the message based on the format information and the converted data.
